(19) United States
(12) Patent Application Publication
(10) Pub. No.: US 2007/0276702 A1
(43) Pub. Date: Nov. 29, 2007

(54) System and Method for Collaboration and Communication in Health Management

(76) Inventor: Sandeep Dani, Eden Prairie, MN (US)

Correspondence Address: FULBRIGHT & JAWORSKI L.L.P., 80 SOUTH EIGHTH STREET, SUITE 2100, MINNEAPOLIS, MN, 55402, US

(21) Appl. No.: 11/754,145

(22) Filed: May 25, 2007

Related U.S. Application Data
(60) Provisional application No. 60/809,140, filed on May 25, 2006.

(51) Int. Cl. G06F 19/00; G06F 17/30

(52) U.S. Cl. 705/3; 707/9; 707/10

(57) ABSTRACT

The present invention is directed to a system and method which provides a platform for organizing, storing, and providing information between users and providers of services. Users interact with an application that provides guidelines that assist in the organization and display of information related to the service. Through the application users are reminded of tasks that need to be performed as well as can obtain information about a service. Providers access the system to review information related to the users in preparation for delivery of the service. Providers can also communicate with the users prior to rendering services.

### CROSS-REFERENCE TO RELATED APPLICATIONS

The present application is a utility of U.S. Provisional Application No. 60/809,140, Attorney Docket No. 50,125-01PROV, entitled “SYSTEM AND METHOD FOR HEALTH INFORMATION,” filed on May 25, 2006, the disclosure of which is hereby incorporated herein by reference.

### TECHNICAL FIELD

The present invention is directed to information management and sharing between users and providers. More specifically the present invention is directed to a system for managing and sharing of medical information among care providers in health management.

### BACKGROUND OF THE INVENTION

Medical records have long been kept in paper form at physician's offices. These records contain valuable medical information about a patient that can be used by other physicians. In today's world people are highly mobile and tend to see physicians in a variety of geographical areas. When a person moves or is referred to another physician large amounts of paper medical information must be transferred along with the patient to the new physician. There is a high likelihood that the receiving physician will not have all of the information that they need to accurately and safely treat the patient. Even in cases where medical information is in electronic format privacy laws and other technical limitations have prevented the easy sharing of this medical information among physicians. As this information is not shared early between physicians and hospitals delays can occur in treatment as physicians wait for records and results to arrive.

People have a keen interest in their health and are actively trying to learn as much about their health as possible. Often times this is the result of businesses requiring their employees and families to manage their own healthcare costs. This has led to the proliferation of medical information websites such as WebMD®. These sites provide people with information related to a variety of health and well being information. However, these sites do not permit users to ask questions to physicians to help diagnose a condition that may or may not require a visit to the physician. Further, the proliferation of these type sites has caused people to misdiagnose themselves and treat themselves without medical advise. This self treatment can result in serious harm to the patient. Additionally, users are not aware of the trustworthiness of the sources of this information.

### BRIEF SUMMARY OF THE INVENTION

The present invention is directed to a system and method which provides a platform for organizing, storing, and providing information between users and providers of services. Users interact with an application that provides guidelines that assist in the organization and display of information related to the service. Through the application users are reminded of tasks that need to be performed as well as can obtain information about a service, procedure, etc. Providers access the system to review information related to the users in preparation for delivery of the service. Providers can also communicate with the users prior to rendering services. Access to the system by the providers may be controlled or limited by the patient.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram of a system according to one embodiment;

FIG. 2 is a screen shot of an exemplary dashboard display;

FIG. 3 is a screen shot of a variation of the exemplary display;

FIG. 4 is a flow diagram illustrating a process of a user interfacing with the system of the present invention; and

FIG. 5 is a flow diagram illustrating a process of a provider interfacing with the system of the present invention.

### DETAILED DESCRIPTION OF THE INVENTION

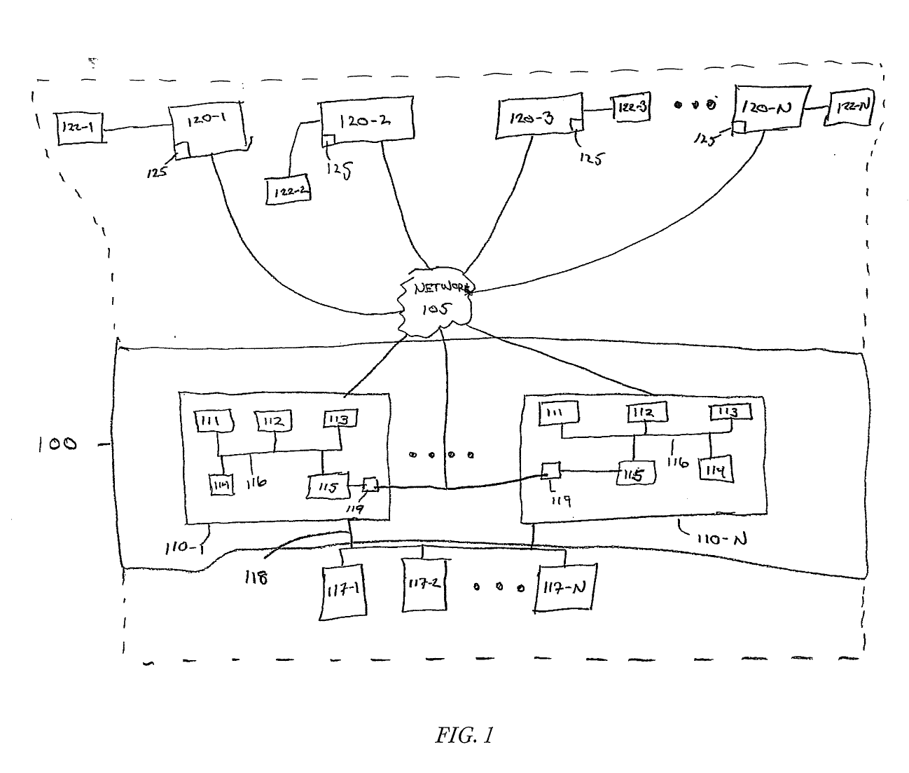

FIG. 1 is a block diagram of a medical information management service 100 according to one embodiment of the present invention. Service 100 includes a number of service locations, such as service locations 110-1, 110-N. Locations 110-1, 110-N are in one embodiment located remote from one another, and are connected to each other through network 105 (e.g., the Internet). Service 100 affords the ability to provide complete medical information and record keeping for a patient and a variety of healthcare providers.

Locations 110-1, 110-N include a number of servers that manage various aspects of both the medical information and medical records. Locations 110-1, 110-N can include, for example, medical image server 111, consultation server 112, email server 113, application server 114, and web server 115. In the illustrated embodiment, each of these servers are connected to one another via connection 116. Further, in some embodiments these servers are located remote from one another.

Image server 111 is a computer or other system that manages medical images. These medical images can include a variety images related to healthcare. For example images on medical image server can include, X-rays, MRI images, CT images, images of organs, images of organs having a particular condition, images of a particular condition, etc. Through the use of image server 111 users of system 100 are able to obtain visual information related to either a patient or a condition. In some embodiments image server 111 also includes forms that are commonly used by healthcare providers or patients. These forms can include intake, insurance reimbursement requests, pre-appointment checklists and the like.

Consultation server 112 is a computer or other system that manages consultations for example, between healthcare providers and patients or between two healthcare providers. As used herein, the term “provider” can include for example, physicians, care givers, family, friends or another patient-authorized person. Consultations allow a patient to communicate with and transmit information to a healthcare provider who is not in the same location as the patient. Additionally, consultation server 112 can allow a physician at one location communicate with an expert in another location and share information related to a patient. In one embodiment consultations occur in a format similar to instant messaging. In another embodiment consultations are performed using video teleconference or other methods. Additionally, consultations can include the monitoring of the user. In these instances, the provider may log into the users data and review the data. Based on the review, the provider can, for example, leave a “note” for the user to perform a specific action.

Email server 113 provides a communications link between various patients and healthcare providers. Through email server 113 patients and healthcare providers can share various documents or transmit other information in a secure environment. Email server 113 can function in a manner similar to consultation server 112. However, email server 113 provides a time delayed (non-real time) communications system. Email server 113 provides the users of system 100 the ability to ask and answer questions over time or transmit documents prior to a scheduled visit with a healthcare provider.

Application server 114 provides a platform upon which users can use or interact with the various components of system 100. Details of exemplary application 125 and functions are discussed in greater detail below. Briefly, however, application server provides a dynamic interface that users of system 100 can use to transmit, enter, or retrieve information desired. Application server 114 provides an application interface (e.g., graphically user interface (GUI)) on a user's computer or other device so that the user can obtain the desired information. This information is provided from other servers in the location.

Web server 115 is a network based server that provides access to the application server 114 and thus system 100 over network 105. This allows users of system 100 to access information and features of service 100 when they are away from their primary computer, or on a computer that does not have the associated application installed on it. Web server 119 can be isolated from the other servers at location 110 through the use of firewalls 115. These firewalls help to prevent hackers or malicious users from accessing information that is stored on system 100.

Connected to location 110 are databases 117-1, 117-2, 117-N. These databases can be local to the specific location or can be remote from location 110 and connected to location 110 via connection 118. If database 117 is remote from location 110 then in some embodiments database 117 may be shared with multiple locations. This helps to ensure that in the event that a specific location goes down users of system 100 are able to access information stored on database 117. Database 117 for example stores information related to a patient, such as, name, date of birth, address, medical history, wellbeing, developmental milestones and the like. This information is then accessible by an authorized healthcare provider who accesses system 100. If the user desires, portions of the information in database 117 may be shielded from a particular provider. The user can limit the amount of information available to any one provider. For example, a user may allow a physician provider unlimited access to the data, and restrict a family member from some data (e.g. psychological reports).

Users interact with system 100 through a variety of client devices such as devices 120-1, 120-2, 120-3, 120-N. For example device 120-1 is a desktop computer, device 120-2 is a personal digital assistant (PDA), device 120-3 is laptop computer and device 120-N is a cellular telephone. Each of the client devices communicates with system 100 through network 105. The connection with network 105 can be either wired or wireless, and can also be accomplished though the use of other connection protocols. The user can load application 125 onto their client device 120-1, 120-2, 120-3, 120-N to provide faster and more secure access to system 100. Application 125 has in one embodiment the ability to change the form factor of a display associated with application 125 in response to the device that it is installed. By modifying the form factor information can be presented to the user in a manner appropriate to the device.

Users access system 100 through application 125. Application 125 provides the portal through which the user can use the features of system 100. Depending on the type of user (e.g. patient, physician, insurance company, etc) application 125 provides a different display or dashboard to the user. The dashboard allows users to access the information in a method and approach that is appropriate for that user. For example, when a patient accesses system 100, dashboard will display information, links and buttons appropriate for a patient. In some embodiments terms will be modified to better match the terms the general public expects to see. However, for a healthcare provider terms may remain in the common medical term. (e.g. Heart Attack vs. Myocardial Infarction).

Information that is stored on database 117 can be downloaded to user device 120. In this approach the user is able to access the information in their record without having to go out to the service 100 every time they desire to update or view information. In some embodiments this information can be downloaded and stored on a portable storage device 122-1, 122-2, 122-3, 122-N (e.g. a flash memory card, CD-ROM, etc.). This allows the user to take their medical information along with them in cases where access to the networked version of system 100 is unavailable (e.g. on a cruise ship, in remote areas, etc.). In additional embodiments, users can also store on device 122 application 125. The storage of application 125 can be useful in situations where access to application 125 is not available.

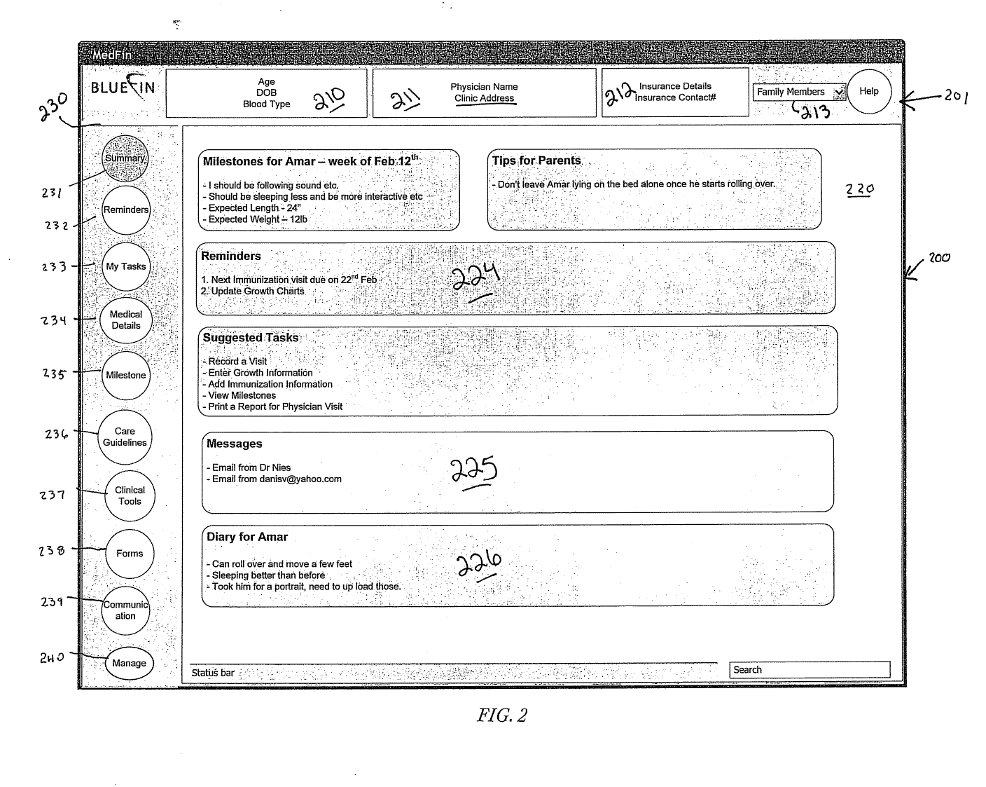

Application 125 also allows users the ability to obtain a large amount of information on various conditions. FIG. 2 shows an exemplary screenshot of dashboard 200 according to one illustrative embodiment. While mention is made to specific information in a specific box, it should be appreciated that other information can be present in these boxes. In this example, dashboard 200 is illustrating a dashboard display configured for an infant. Top portion 201 of dashboard 200 are boxes for placing information related to the patient/user. In this example box 210 allows for the display/entry of information related to the patient's age, blood type and data of birth. In box 211 a physicians name and a clinic's address can be provided. In some embodiments in box 211 a link can be provided which causes a map to appear showing the location of the clinic. In box 212 insurance details can be shown. Box 213 allows for the switching between various users or family members who are accessible by the person logged into application 125.

Center section 220 of dashboard 200 provides a list of specific tasks, reminders, milestones, tips and diary or journal entries. Each of these boxes or areas allow for the user to either view or enter information into the application. For example, the user can click on diary box 226 and enter in information related to the daily activity of a child or patient. This information can then be accessed later by a healthcare provider to view the activity of the patient. This may provide a more accurate and detailed look at a patient's activity than would be associated with the patient remembering activity or symptoms at a later time.

Box 224, for example, shows a listing of reminders for the user. In the example illustrated the reminders include a reminder of the next vaccination that is required and to update a growth chart. In the example where the patient is an adult male, a reminder to have a procedure (e.g., colonoscopy) could appear following a milestone date (e.g., his 40^{th} birthday). The reminder can remain visible until the appropriate action is taken. From the reminders, the user can view various information related to the reminders. For example, if the user desires to find out what a colonoscopy procedure is, the user can be presented with a link to find out more information. If the user accesses the link, application 125 communicates with medical image server 111 of system 100 and requests information related to a colonoscopy. The server 111 can return to the user a description of the procedure and also provide a video image of the procedure, or an image of what the physician is looking for during the procedure.

Box 225, for example, shows a list of emails that have been received by application 125. Emails that are received by application 125 are sent to an email address associated with system 100. These emails are processed by email server 113 and then delivered to the user when they log onto system 100. The user can access the email by, for example, clicking on the email. In some embodiments box 225 can also allow the user to send a context sensitive email, e.g. to request an online consultation, using a single option and sending the email. If an online consultation is requested, system 100 will identify a provider who can consult with the patient. Contextual information is transmitted to the provider via consultation server 112. Through this approach the user and provider have access to the same information. If during the consultation the provider needs to ask a question, the provider can have the user view an item from the medical image server to determine if the condition is similar to the image. This helps the provider diagnose the patient from a remote distance.

On the left hand side 230 of dashboard 200 is a listing of actions/tasks 231-240 that are commonly performed by the user. Each of these actions/tasks is represented by an icon or other indicator that is clickable by a user. Application 125 customizes the actions/tasks based on factors such as person's age, sex, race, medical needs, and usage patterns, however, other factors of a user profile can be used. The more frequently an action or task is performed the higher it will be in the list to enable faster access and recognition. In some embodiments if a specific action or task has been designated a high priority action or task it can be moved to the top of the list. (e.g. a vaccination needs to be administered, or a test needs to be scheduled). Application 125 can update the task list order every time the user logs into the system, or can update the order on a regular basis.

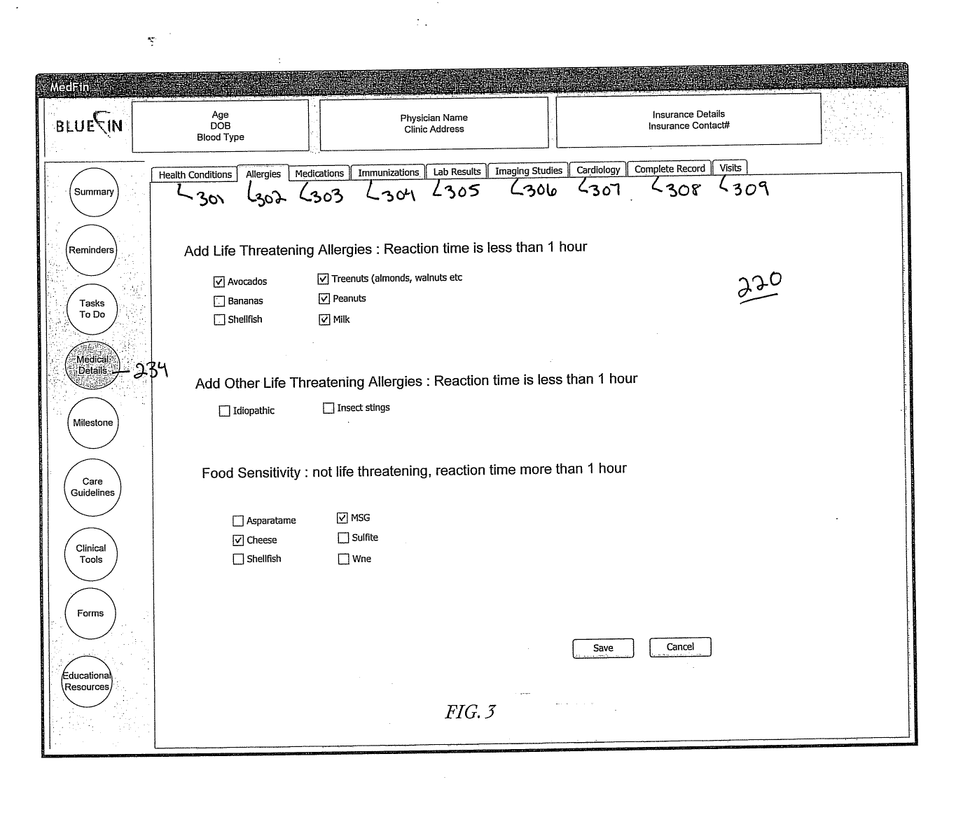

When the user clicks on one of the tasks 231-240 in section 230, the center section 220 of the dashboard 200 changes to display information related to the highlighted task. An example of a change in center section 220 is illustrated in FIG. 3. FIG. 3 shows an exemplary screen for entering in allergy information following the clicking of a medical details task 234. At the top 300 of the center section are a number of tabs 301-309 for viewing or editing various components of a persons medical history.

All of the information that is entered by users into system 100 through application 125 are stored on database 117. As mentioned before, this information can also be stored on portable storage device 122 and carried with the person. When a patient visits a physician or other healthcare provider, the physician can access the information in database 117 to become familiar with the status of the patient, or to review the patient's progress remotely. However, the user can limit the amount of information shared with any provider. This is achieved through the use of security or other protocols.

Through the use of dashboard 200, the user is able to review their entire medical history. Various tabs allow the user to obtain information related to upcoming visits with a healthcare provider. For example, users can pre-fill forms out prior to arriving at a physician's office, or can print out a listing of steps associated with a procedure (e.g., office visit, diagnostic test, etc.) This allows the user to know what to expect, and also allows the user to verify that proper medical care is being given.

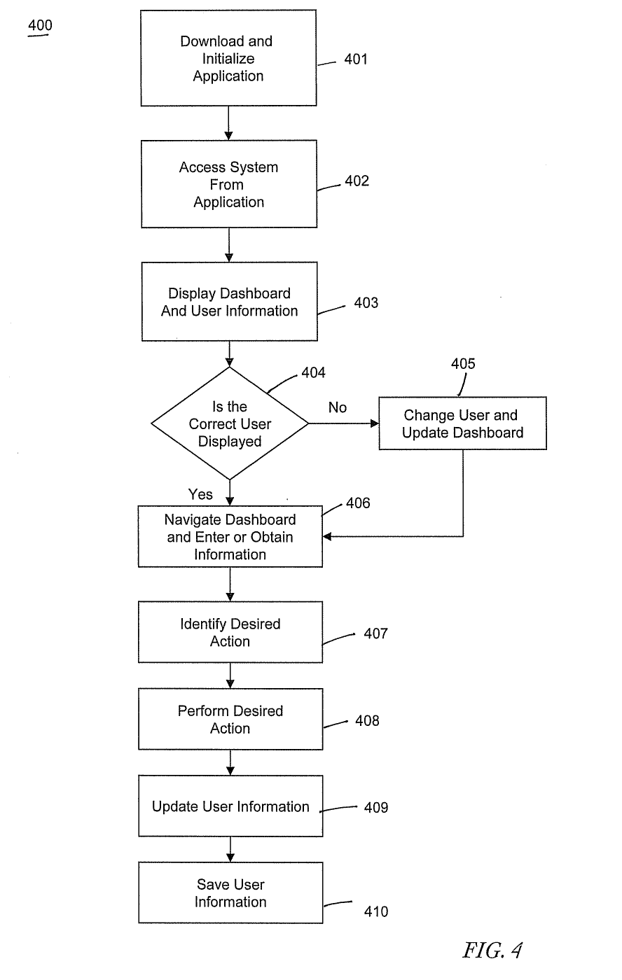

FIG. 4 is a flow diagram illustrating a process 400 for using system 100 of the present invention. Process 400 begins when the user first accesses application 125. At process 401 the user downloads or accesses application 125. The user is prompted to provide information to establish an account with system 100 (e.g. name, address, login information). This creates a basic profile for the user. Next the user at process 402 logs into system 100. This allows the system to identify the user and access the appropriate data in database 117.

Once into system 100, dashboard 200 is displayed on the user's device 120 at process 403. Typically, upon start-up the user is presented with a summary page for the default user that provides quick viewing of reminders, appointments, or other tasks that require attention. If the user desires to pull up another family member they can do so at process 404. At process 405 system 100 accesses the information in database 117 for this user and displays information for this user on dashboard 200.

At process 406, the user navigates through the dashboard to obtain or enter information into system 100. This can include such activities as entering data into the system or reviewing symptoms to identify a problem (e.g., requesting images of a condition from server 111). Of course a variety of other activities can be performed at process 406. If the user has decided that they need to take an action, for example, make an appointment at process 407, system 100 can help the user make an appointment with a physician, at process 408. In other examples, users can send email to a physician at process 408. For example, system 100 can access a physician's appointment schedule and allow the user to schedule the appointment directly from the system. Once the appointment has been scheduled system 100 can update the reminders section (or any other portion of the dashboard) at process 409, and can also provide a display that allows the user to know what to expect at the appointment.

When the user is finished with using the system, the user can save the information at process 410. This information can be saved either to database 117, to portable storage device 122 or both. Preferably, if information is stored to device 122 it is also stored to database 117 as well.

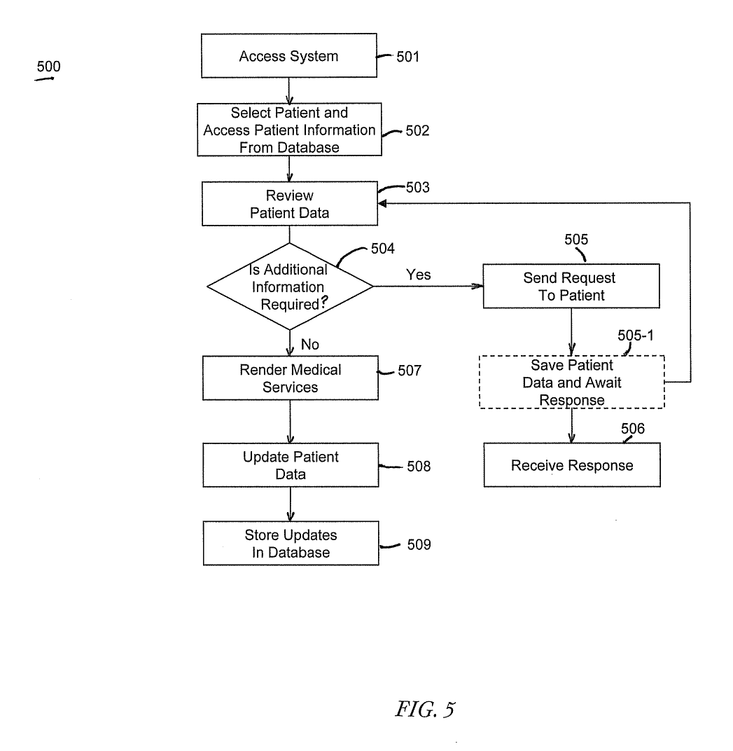

FIG. 5 is a flow diagram illustrating process 500 for a healthcare provider or other provider accessing system 100 according to one embodiment of the present invention. The healthcare provider accesses system 100 at process 501. Once into system 100 the healthcare provider can access the data in database 117 for a specific patient at process 502. At process 502 the physician selects the name of the patient from dashboard 200. This causes the information stored in database 117 to be displayed to the physician. In some embodiments the physician is limited to the accessing only the data permitted by their patients.

At process 503 the provider reviews the data for a patient. This can include reviewing such information as diary entries and other medical records. Based on this review the provider is able to prepare for the office visit or determine if additional information is needed from the patient at process 504. If additional information is required from the patient then the provider can send a message or form to the patient to request this additional information at process 505. In some embodiments, the physician stores this request on database 117 and awaits a response from the patient at optional process 505-1. The additional information is received at process 506. The physician then reviews this additional information by returning to process 503.

If no additional information is required the physician can provide medical services at process 507. If the medical services are provided in an office visit the provider and the user can review together the information at process 507. Otherwise the medical services are provided through system 100. Based on the actions taken during the visit, the patient's records can be updated in system 100 at process 508. The updated data is stored in database 117 at process 509. Also included in the stored records is data related to the provider who accessed the patient's records. This auditing and journaling feature helps to detect fraud or other unethical behaviors.

It should be noted that while the above description has been directed towards medical information sharing and storing the principles discussed above may be applied to other areas where the need to share information between users and providers of services exists. For example, the above principles can be applied to consulting services, legal services, and the like.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
retrieving patient information from a database connected to a remote medical information management system, said retrieving being limited to a portion of a total patient information within the system as authorized by a patient;
reviewing by a provider said portion of said total patient information at said provider's location;
determining new patient information based on said provider reviewing; and
storing said new patient information at said database such that said new patient information is accessible by said patient and other providers remote from said provider.

2. The method of claim 1 wherein entering additional information comprises:
sending a request to said patient a request for information; and
receiving a response to said request from said patient.

3. The method of claim 1 wherein entering additional information comprises:
sending an electronic file from said information system to said patient.

4. The method of claim 1 wherein said reviewing further comprises:
initiating a consultation session with a patient.

5. The method of claim 4 wherein the consulting session further comprises:
monitoring remotely said patient.

6. The method of claim 4 wherein initiating said consultation session comprises:
communicating with a consultation server on said management system; and
connecting with a patient's client device from said consultation server.

7. The method of claim 1 wherein retrieving further comprises:
determining an authorization level of the provider; and
providing only that information in the patient database associated with said authorization level.

8. A method of managing personal health information, comprising:
accessing an application program having a graphical user interface, said application program in communication with a remote medical information system;
navigating said application program to review personal health information of a patient, said navigating being limited to portions of said medical information system as authorized by said patient; and
updating said personal health information on a remote database based on said review, with updated personal health information being available to another provider based upon an authorization by said patient.

9. The method of claim 8 wherein navigating further comprises:
identifying an area of concern;
requesting additional information related to said area of concern from said information system; and
receiving additional information related to said area of concern from said information system.

10. The method of claim 9 wherein receiving additional information comprises:
receiving an electronic file from said information system; and
viewing said file on said application.

11. The method of claim 9 wherein receiving additional information comprises:
initiating a consultation with a healthcare provider.

12. The method of claim 11 wherein said consultation comprises:
transmitting said personal health information to said healthcare provider; and
receiving information from said healthcare provider in response to said personal health information.

13. The method of claim 12 wherein receiving information further comprises:
receiving an electronic file from said information system in response to information from said healthcare provider.

14. The method of claim 8 wherein updating further comprises:
storing said personal heath information on a portable data storage device.

15. The method of claim 14 wherein accessing further comprises:
accessing said personal health information from said portable data storage device.

16. The method of claim 9 further comprising:
sending a message to a healthcare provider in response to said area of concern.

17. The method of claim 8 wherein updating further comprises:
setting authorization levels for said personal health information.

18. An information management system comprising:
at least one service location communicatively connected to a plurality of client devices, said client devices representative of users and providers of the system;
an application program providing connectivity between said plurality of client devices and said at least one service location; and
at least one database communicatively connected to said at least one service location storing data related to a user of said information management system, with some of said data being accessible to a first provider and other of said data being accessible only to a second provider as authorized by said user.

19. The information management system of claim 18 wherein said at least one service location comprises:
an image server providing information and images to said client devices in response to requests for information and images;
a communications server providing communications services between said client devices;
a consultation server providing consultation service features between said client devices;
an application server providing connectivity between an application program on said client devices and said servers on said service location; and
a network server providing access to said application server from devices other than said client devices.

20. The information management system of claim 18 further comprising:
a portable storage device storing said information related to said user.

21. The information management system of claim 20 wherein said portable storage device further stores a copy of said application program.

22. The information management system of claim 18 wherein said application program further comprises:
a graphical user interface displaying a plurality of tasks based in part on information stored in said database, said tasks arranged in an order of importance.

23. The information management system of claim 22 wherein said order of importance is automatically updated based on a user profile.
